(19) United States
(12) Patent Application Publication
(10) Pub. No.: US 2015/0103134 A1
(43) Pub. Date: Apr. 16, 2015

(54) VIDEO CONVERSATION METHOD, VIDEO CONVERSATION TERMINAL, AND VIDEO CONVERSATION SYSTEM

(71) Applicant: Tencent Technology (Shenzhen) Company Limited, Guangdong (CN)

(72) Inventor: Jie Cheng, Guangdong (CN)

(21) Appl. No.: 14/576,294

(22) Filed: Dec. 19, 2014

Related U.S. Application Data
(63) Continuation of application No. PCT/CN2014/078651, filed on May 28, 2014.

(30) Foreign Application Priority Data
May 30, 2013 (CN) 201310208259.0

(51) Int. Cl. H04N 7/14

(52) U.S. Cl. CPC H04N 7/147
USPC 348/14.07; 348/14.01

(57) ABSTRACT

Described are a video conversation method, a video conversation terminal, and a video conversation system. The video conversation method includes: the first conversation terminal sending an effect change request to a second conversation terminal; the second conversation terminal changing effect to current local video data of the second conversation terminal according to the effect change request; and the second conversation terminal sending video data which effect is changed to the first conversation terminal. During the video conversation, the video conversation method adds effect to both sides of the video conversation, and improves an interactivity of the video conversation.

### CROSS REFERENCE TO RELATED APPLICATIONS

This application is a U.S. continuation application under 35 U.S.C. §111(a) claiming priority under 35 U.S.C. §§120 and 365(c) to International Application No. PCT/CN2014/078651 filed on May 28, 2014, which claims the priority benefit of Chinese Patent Application No. 201310208259.0, filed on May 30, 2013, the contents of which are incorporated by reference herein in their entirety for all intended purposes.

### FIELD OF THE TECHNOLOGY

The present disclosure relates to computer field, and more particularly, to a video conversation method, a video conversation terminal, and a video conversation system.

### BACKGROUND

Video conversation is a communication of transmitting sound and images in real time based on Internet or mobile Internet. With a rapidly improvement of network band width and a development of hardware device, a market of video conversation is developed fast. A facial decoration effect used dynamically in the video conversation is a research and development direction in the video conversation technology. In a typical video conversation decoration technology, only some parts of a local video image can be added with a decoration effect. However, the decoration effect can not be added to the video image of other part at the same time. Thus, the two parts of the video conversation can not interact with each other on this function.

### SUMMARY

Exemplary embodiments of present disclosure provide a video conversation method, a video conversation terminal, and a video conversation system. The exemplary embodiments can add effect to both sides of the video conversation, and improve an interactivity of the video conversation.

According to a first aspect of present disclosure, a video conversation method is provided. The video conversation method includes:

a first conversation terminal sending an effect change request to a second conversation terminal;

the second conversation terminal changing effect to current local video data of the second conversation terminal according to the effect change request; and

the second conversation terminal sending video data which effect is changed to the first conversation terminal.

According to a second aspect of present disclosure, a video conversation terminal is provided. The video conversation terminal includes:

an effect request obtaining module, configured to obtain an effect change request sent from a first conversation terminal;

an effect changing module, configured to change effect to current local video data of a second conversation terminal according to the effect change request; and

a video conversation module, configured to send video data which effect is changed to the first conversation terminal.

According to a third aspect of present disclosure, a video conversation terminal is provided. The video conversation terminal includes:

an effect request sending module, configured to send an effect change request to a second conversation terminal, request the second conversation terminal to change effect to current local video data; and

a video conversation module, configured to obtain the video data which effect is changed from the second conversation terminal.

According to a fourth aspect of present disclosure, a video conversation system is provided. The video conversation system includes a first conversation terminal and a second conversation terminal.

The first conversation terminal is a video conversation terminal provided in the third aspect of present disclosure. The first conversation terminal is configured to send an effect change request to a second conversation terminal, obtain video data which effect is changed sent from the second conversation terminal.

The second conversation terminal is a video conversation terminal provided in the second aspect of present disclosure. The second conversation terminal is configured to obtain the effect change request sent from the first conversation terminal, change effect to current local video data according to the effect change request, and send the video data which effect is changed to the first conversation terminal.

In the embodiments of present disclosure, both sides of the video conversation can send effect change request to each other. Thus, during the video conversation, each side of the video conversation can add or clear effect to itself and the other side of the video conversation. Interactivity and flexibility of the video conversation is improved during the conversation, and use experience of the video conversation is also improved.

### BRIEF DESCRIPTION OF THE DRAWINGS

In order to make the embodiment of present disclosure or the embodiment of prior art more clearly, the drawings which are needed in the embodiment of present disclosure or the embodiment of prior art are described simply as follows. It is obviously, the drawings described as the follows are only exemplary embodiments of present disclosure. To a person of ordinary skill in the art, under premise of no creative work, other drawings may be obtained according to the drawings.

FIG. 1 is a flowchart of a video conversation method according to one embodiment of present disclosure.

FIG. 2 is a flowchart of a video conversation method according to another embodiment of present disclosure.

FIG. 3 is a flowchart of a video conversation terminal changing effect to a current local video data.

FIG. 4 is a schematic diagram of a video conversation terminal according to one embodiment of present disclosure.

FIG. 5 is a schematic diagram of an effect changing module of the video conversation terminal according to one embodiment of present disclosure.

FIG. 6 is a schematic diagram of a video conversation terminal according to another embodiment of present disclosure.

FIG. 7 is a schematic diagram of an effect request sending module of the video conversation terminal according to another embodiment of present disclosure.

### DETAILED DESCRIPTION OF ILLUSTRATED EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

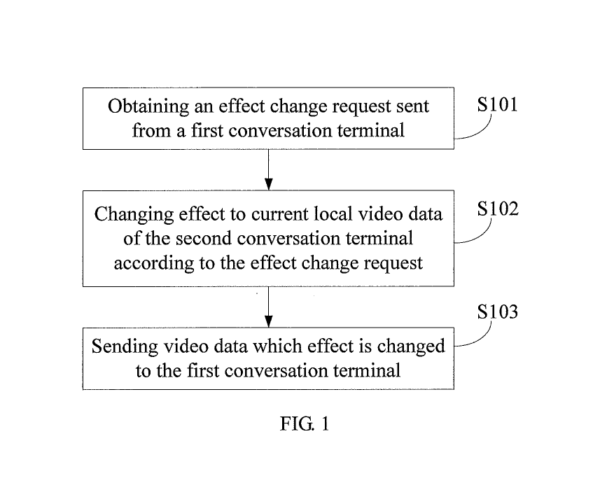

Referring to FIG. 1, FIG. 1 is a flowchart of a video conversation method according to one embodiment of present disclosure. The video conversation method of present disclosure can be applied on network terminal or mobile network terminal, such as, person computer (PC), mobile phone, panel computer, etc. The video conversation method includes at least the following steps.

Step S101, a second conversation terminal obtains an effect change request sent from a first conversation terminal. In detail, a video conversation is established between the first conversation terminal and the second conversation terminal by executing a video conversation program, and a signal path of interchanging a message or data of video effect is established by executing the video conversation program. In another embodiment, the message or data of video effect is interchanged by a conversation path which is established before. When the first conversation terminal establishes a video conversation with the second conversation terminal, a user of the first conversation terminal can send the an effect change request to the second conversation terminal by operating on a video conversation interface. The effect change request is configured to request the second conversation terminal to change effect to video data of the second conversation terminal. The effect change request includes an effect adding request and an effect clearing request. The effect change request can also include target effect identification. The effect change request is configured to notify the second conversation to add or clear target effect material corresponding to the target effect identification. Alternatively, the effect clearing request may not include target effect identification. At this time, the effect clearing request is configured to request the second conversation terminal to clear all the effects which are added or the effect which is added last time from current video data.

Step S102, the second conversation terminal changes effect to current local video data of the second conversation terminal according to the effect change request. In detail, the second conversation terminal obtains an effect material collection in advance from a server. In an example, the effect material collection can be obtained from the server when establishing the video conversation with the first conversation terminal. The effect material collection includes at least one effect material and an effect identification corresponding to each effect material. Alternatively, the effect material collection includes an effect type corresponding to each effect material. The effect type may be eye effect, moustache effect, hat effect, background effect, etc. For example, an xml file is established to describe information of each effect, such as, effect identification, effect material, facial width ratio, facial height ratio, key point coordinate, key point index and effect type, etc. When receiving the effect change request, the second conversation terminal reads the information of the xml file, and precisely combines the effect material with the current local video data. In detail, when the second conversation terminal receives the effect change request, the second conversation terminal inquiries the user whether change effect to the current local video data according to the effect change request. If the user agrees to change effect to the current local video data, the second conversation terminal changes effect to the current local video data. To the effect adding request, the second conversation terminal searches the target effect material from the effect material collection according to the target effect identification of the effect change request, combines the current local video data of the second conversation terminal with the target effect material. To the effect clearing request, the second conversation terminal clears all the effect materials from the current local video data, or clears the effect material corresponding to target effect indemnification of the effect clearing request from the current local video data.

Step S103, the second conversation terminal sends video data which effect is changed to the first conversation terminal. In detail, the second conversation terminal sends the video data which effect is changed to the first conversation terminal. Thus, in the video conversation, the video data which effect is changed can be seen from the first conversation terminal.

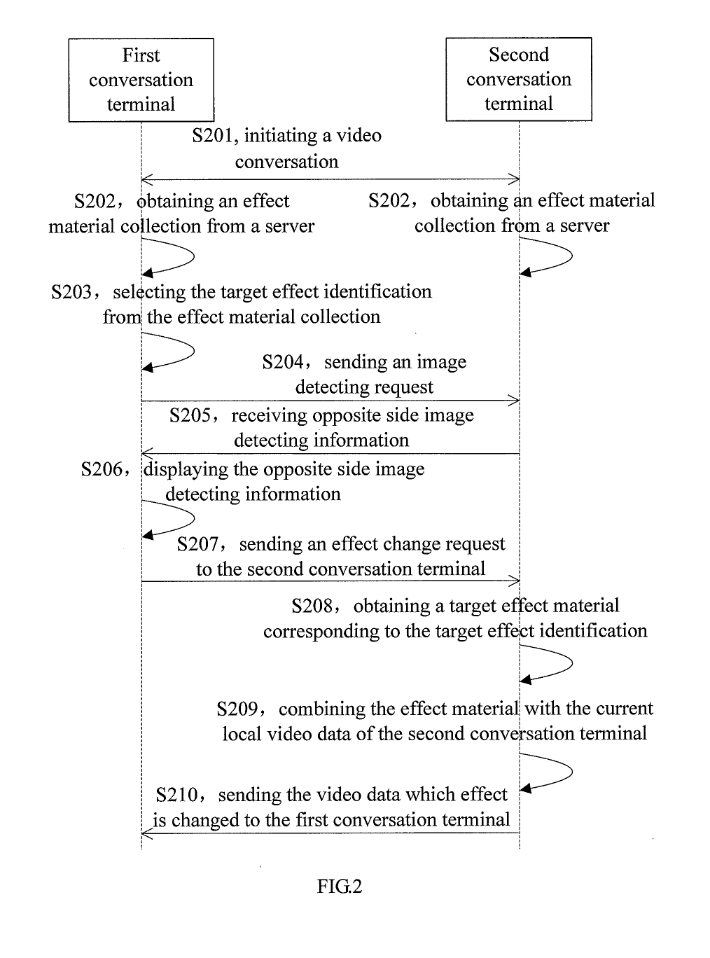

Referring to FIG. 2, FIG. 2 is a flowchart of a video conversation method according to another embodiment of present disclosure. The video conversation method of the embodiment of present disclosure includes the following steps.

Step S201, initiating a video conversation. In detail, a first conversation terminal or a second terminal sends a request for establishing a video conversation to the other part according to an operation of the user via a video conversation program.

Step S202, the first conversation terminal and the second conversation terminal obtain an effect material collection from a server respectively. In detail, taking the first conversation terminal initiates the video conversation for example, the first conversation terminal automatically obtains the effect material collection from the server when the second conversation terminal initiates the request for establishing the video conversation. The second conversation terminal automatically obtains the effect material collection from the server when receiving the request for establishing the video conversation. Each effect collection can be associated with a login account, and the effect collections can be the same with each other, or can not be the same with each other. In an alternative embodiment of present disclosure, the first conversation terminal and the second conversation terminal obtain the effect material collection from the server before the step S201. For example, the first conversation terminal and the second conversation terminal actively obtain the effect material collection from the server according to an instruction of the user. Or the first conversation terminal and the second conversational terminal obtain effect material collection from the server from the last video conversation, and store the effect material collection into a preset file or a preset database. The effect material collection is the same with the effect material collection described above, and it is not repeated again here.

Step S203, the first conversation terminal selects the target effect identification from the effect material collection. In detail, the first conversation terminal analyzes the effect material collection, exhibits effect thumbnails of all of or part of the effect materials on an effect menu of a program interface, obtains an operation to the effect thumbnail which is selected by clicking the effect menu, and obtains the target effect identification corresponding to the effect material which is selected by the user.

Step S204, the first conversation terminal sends an image detecting request to the second conversation terminal. In detail, the first conversation terminal sends the image detecting request to the second conversation terminal when receiving the target effect identification selected by the user. For example, when obtaining the operation to the effect thumbnail, the first conversation terminal sends the image detecting request to the second conversation terminal, and request the second conversation terminal to feed back image detecting information. In other alternative embodiment of present disclosure, there is no certain order requirement of the step S203 and the step S204, such as the step S204 can be implemented before the step S203.

Step S205, the second conversation terminal feeds back opposite side image detecting information to the first conversation terminal. In detail, when receiving the image detecting request sending from the first conversation terminal, the second conversation terminal starts a local image detecting component, detects current local video image, and obtains the image detecting information. Take detecting a face of the video image for example, the image detecting information is displaying a blue frame for tracking face on the local video image to indicate the area in the blue frame is face. The second conversation terminal obtains the image detecting information via the image detecting component. The image detecting information is the opposite side image detecting information of the embodiment. The second conversation terminal sends the opposite side image detecting information to the first conversation terminal in a certain time period.

Step S206, the first conversation terminal displays the opposite side image detecting information. In detail, the first conversation terminal displays the opposite side image detecting information on a display window provided by the video conversation program. In the embodiment, the first conversation terminal starts the local image detecting component, detects current local video image, obtains the local image detecting information, and displays the local image detecting information together with the opposite side image detecting information.

Step S207, the first conversation terminal sends an effect change request to the second conversation terminal. In detail, the first conversation terminal sends the effect change request to the second conversation terminal according to the opposite side image detecting information. The first conversation terminal displays the local image detecting information together with the opposite side image detecting information as described above. When the user moves the effect thumbnail selected in the step S203 to the opposite side image detecting information, the first conversation terminal sends the effect change request to the second conversation terminal. The effect change request includes the target effect identification of the target effect material selected by the user. In other embodiment of present disclosure, when the user of the first conversation terminal wants to require the second conversation terminal to clear all the effect materials of the current local video data, the user can select a clearing instruction, then select the opposite side image detecting information, and the first conversation terminal sends an effect change request for clear all the effect materials.

Step S208, the second conversation terminal obtains a target effect material corresponding to the target effect identification. In detail, when the second conversation terminal receives the effect change request sent from the first conversation terminal, the second conversation terminal searches the effect material collection according to the target effect identification, and obtains the target effect material corresponding to the target effect identification.

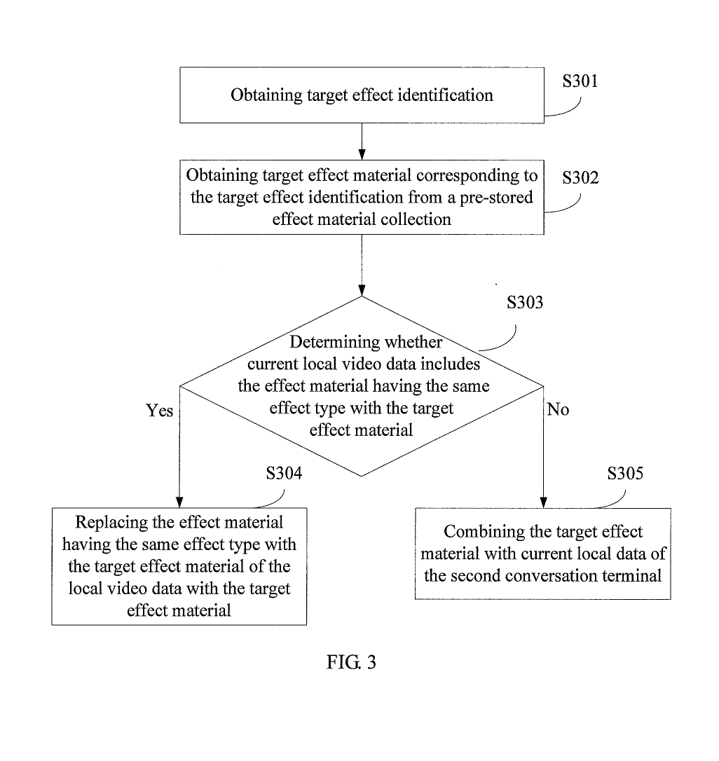

Step S209, the second conversation terminal combines the effect material with the current local video data. A detail process of changing effect to the current local video data is illustrated combining with FIG. 3 as follows.

Step S210, the second conversation terminal sends the video data which effect is changed to the first conversation terminal, and displays the video data which effect is changed on the first conversation terminal during the video conversation.

Referring to FIG. 3, FIG. 3 is a flowchart of a video conversation terminal changing effect to a current local video data. At least following steps are included in the embodiment.

Step S301, obtaining target effect identification. In detail, the video conversation terminal obtains an effect change request sent from the other part of the video conversation terminal, obtains target effect identification. In another alternative embodiment of present disclosure, the video conversation terminal selects an effect material from all of or part of the effect thumbnails displayed on the effect menu on the program interface, obtains effect identification of the effect material selected by the user as the target effect identification, obtains the effect thumbnail of the target effect material clicked by the user, obtains the operation of moving the effect thumbnail to the display window of the local image detecting information, changes effect to the current local video data.

Step S302, obtaining target effect material corresponding to the target effect identification from a pre-stored effect material collection. In the embodiment, the effect material collection includes at least one effect material. Each of the effect material is corresponding to effect identification and an effect type. For example, the effect type can be eye effect, moustache effect, hat effect, background effect, etc.

Step S303, determining whether current local video data includes the effect material having the same effect type with the target effect material. If so, a step S304 is implemented; otherwise, a step S305 is implemented.

Step S304, replacing the effect material having the same effect type with the target effect material of the local video data with the target effect material.

Step S305, combining the target effect material with current local data of the second conversation terminal. In detail, the video conversation terminal reads xml information of the effect material collection, and precisely combines the target effect material with the current local video data.

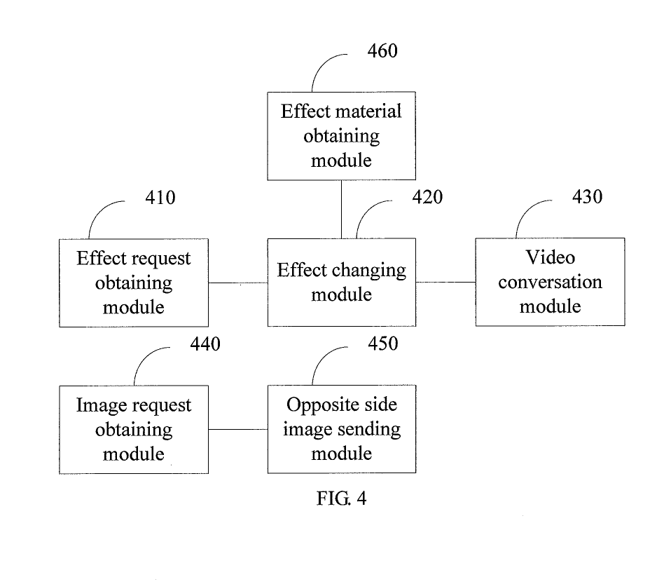

Referring to FIG. 4, FIG. 4 is a schematic diagram of a video conversation terminal according to one embodiment of present disclosure. The video conversation terminal can be Internet terminal or mobile Internet terminal, such as personal computer (PC), mobile phone, panel computer. In the embodiment, a video conversation is established between the video conversation terminal and a first conversation terminal by executing a video conversation program. The video conversation terminal serves as a second conversation terminal in the embodiment. The second conversation terminal is illustrated in detail by representing the video conversation terminal in the embodiment. As shown in FIG. 4, the video conversation terminal includes at least the following modules in the embodiment.

An effect request obtaining module 410, which is configured to obtain an effect change request sent from a first conversation terminal.

In detail, a video conversation is established between the first conversation terminal and the second conversation terminal by executing a video conversation program, and a signal path of interchanging a message or data of video effect is established by executing the video conversation program. In another embodiment, the message or data of video effect is interchanged by a conversation path which is established before. The effect request obtaining module 410 obtains an effect change request from the first conversation terminal. In detail, during the video conversation between the first conversation terminal and the second conversation terminal, a user of the first conversation terminal sends an effect change request to the second conversation terminal by operating on a video conversation interface. The effect change request is configured to request the second conversation terminal to change effect to video data of the second conversation terminal. The effect change request includes an effect adding request and an effect clearing request. The effect change request can also include target effect identification. The target effect identification is configured to notify the second conversation add or clear target effect material corresponding to the target effect identification. Alternatively, the effect clearing request may not include target effect identification. At this time, the effect clearing request is configured to request the second conversation terminal to clear all the effects which are added or the effect which is added last time from current video data.

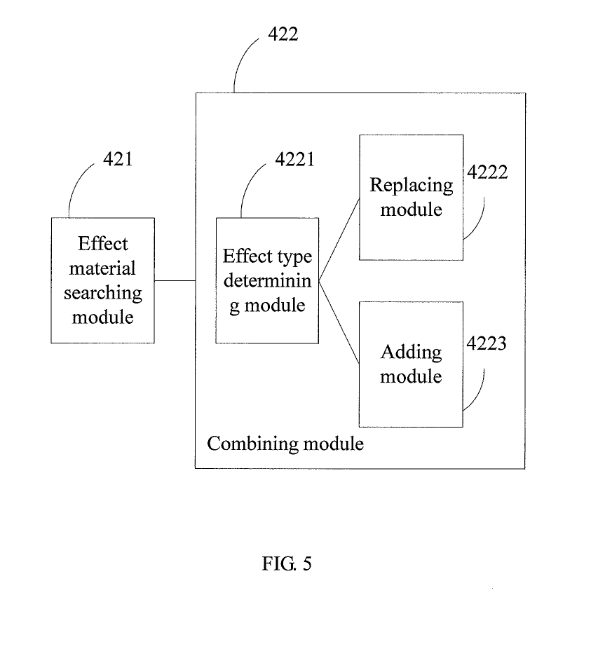

An effect changing module 420, which is configured to change effect to current local video data of the second conversation terminal according to the effect change request. In detail, when the second conversation terminal receives the effect change request, the second conversation terminal inquires the user whether change effect to the current local video data according to the effect change request. If the user agrees to change effect to the current local video data, the effect changing module 420 changes effect to the current local video data. If the effect change request is an effect adding request, the effect changing module 420 changes effect to the current local video data according to the effect change request, combines the current local video data of the second conversation terminal with the target effect material. If the effect change request is an effect clearing request, the effect changing module 420 clears all the effect material from the current local video data, or clears the target effect identification of the effect clearing request from current local video data, or clears effect material corresponding to the target effect type. The effect material collection includes at least one effect material and an effect identification corresponding to each effect material. Alternatively, the effect material collection includes an effect type corresponding to each effect material. The effect type may be eye effect, moustache effect, hat effect, background effect, etc. For example, an xml file is established to describe information of each effect, such as, effect identification, effect material, facial width ratio, facial height ratio, key point coordinate, key point index and effect type, etc. Alternatively, as shown in the FIG. 5, the effect changing module 420 further includes the following modules.

An effect material searching module 421, which is configured to obtain target effect material corresponding to the target effect identification from a pre-stored effect material collection.

A combining module 422, which is configured to combine the target effect material with current local data. In detail, the combining module 422 reads xml information of the effect material collection, and precisely combines the target effect material with the current local video data. The combining module 422 includes the following modules.

An effect type determining module 4221, which is configured to determine whether current local video data includes the effect material having the same effect type with the target effect material.

A replacing module 4222, which is configured to replace the effect material having the same effect type with the target effect material of the current local video data with the target effect material, when the effect type determining module 4221 determines the current local video data includes the effect material having the same effect type with target effect material.

An adding module 4223, which is configured to combine the target effect material with current local data of the second conversation terminal, when the effect type determining module 4221 determines the current local video data does not include the effect material having the same effect type with target effect material.

A video conversation module 430, which is configured to send video data which effect is changed to the first conversation terminal. In detail, the video conversation module 430 sends the video data which effect is changed to the first conversation terminal. Thus, the video data which effect is changed can be seen in the video conversation between the first conversation terminal and the second conversation terminal.

Alternatively, the video conversation terminal in the embodiment further includes the following modules.

An opposite side image sending module 450, which is configured to send opposite side image detecting information to the first conversation terminal. In detail, the opposite side image sending module 450 starts a local image detecting component, detects current local video image, and obtains the image detecting information. Take detecting a face of the video image for example, the image detecting information is displaying a blue frame for tracking face on the local video image to indicate the area in the blue frame is face. The second conversation terminal obtains the image detecting information via the image detecting component. The image detecting information is the opposite side image detecting information of the embodiment. The opposite side image sending module 450 sends the opposite side image detecting information to the first conversation terminal in a certain time period.

Alternatively, the video conversation terminal in the embodiment further includes the following modules.

An image request obtaining module 440, which is configured to obtain an image detecting request sent from the first conversation terminal, and trigger the opposite side image sending module 450 to send the image detecting information to the first conversation terminal according to the image detecting request. In detail, according to an instruction of the user, the first conversation terminal sends the image detecting request to the second conversation terminal when receiving the target effect identification selected by the user, and requests the second conversation terminal to feed back image detecting information. When receiving the image detecting request sent from the first conversation, the image request obtaining module 440 triggers the opposite side image sending module 450 to send the opposite side image detecting information to the first conversation terminal.

Alternatively, the video conversation terminal in the embodiment further includes the following modules.

An effect material obtaining module 460, which is configured to obtain the effect material collection from a server. In detail, the effect material obtaining module 460 can automatically obtain the effect material collection from the server when the first conversation terminal initiates a request for establishing the video conversation, or when receiving the request initiated by the first conversation for establishing the video conversation. The effect material obtaining module 460 can also obtain the effect material collection before initiating the video conversation. For example, the effect material obtaining module 460 automatically obtains the effect material collection from the server according to an instruction of the user, or the effect material obtaining module 460 obtains effect material collection from the server from the last video conversation, and store the effect material collection into a preset file or a preset database.

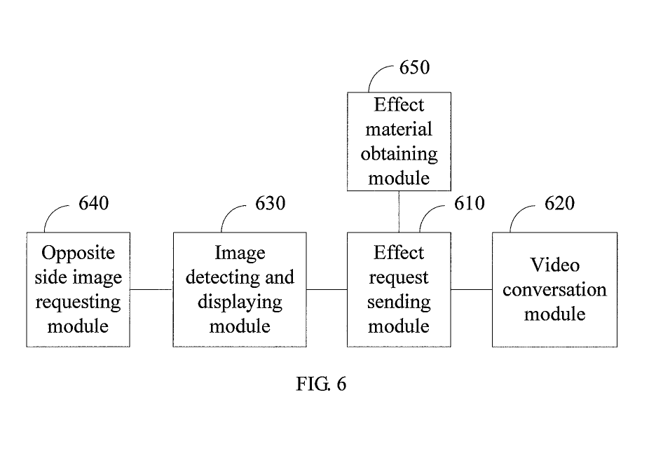

Referring to FIG. 6, FIG. 6 is a schematic diagram of a video conversation terminal according to another embodiment of present disclosure. The video conversation terminal can be Internet terminal or mobile Internet terminal, such as personal computer (PC), mobile phone, panel computer. In the embodiment, a video conversation is established between the video conversation terminal and a second conversation terminal by executing a video conversation program. The video conversation terminal serves as a first conversation terminal in the embodiment. The first conversation terminal is illustrated in detail by representing the video conversation terminal in the embodiment. As shown in FIG. 6, the video conversation terminal includes at least the following modules in the embodiment.

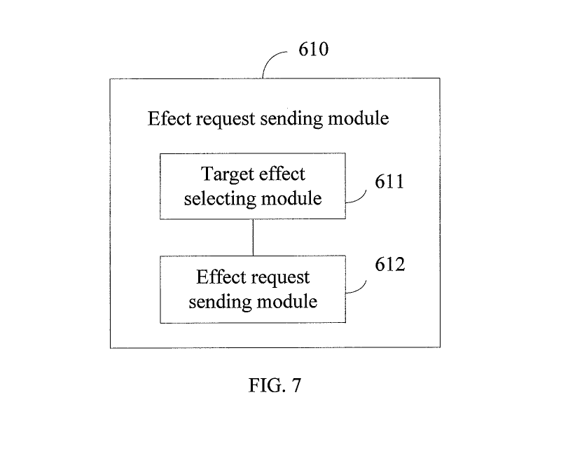

An effect request sending module 610, which is configured to send an effect change request to the second conversation terminal, request the second conversation terminal to change effect to current local video data. In detail, when the first conversation terminal establishes a video conversation with the second conversation terminal, a user of the first conversation terminal can send an effect change request to the second conversation terminal by operating on a video conversation interface. During the video conversation between the first conversation terminal and the second conversation terminal, a user of the first conversation terminal operates to the second conversation terminal on a video conversation interface, the effect request sending module 610 request the second conversation terminal to change effect to video data of the second conversation terminal according to the operation of the user. The effect change request includes an effect adding request and an effect clearing request. The effect change request can also include target effect identification. The target effect identification is configured to notify the second conversation add or clear target effect material corresponding to the target effect identification. Alternatively, the effect clearing request may not include target effect identification. At this time, the effect clearing request is configured to request the second conversation terminal to clear all the effects which are added or the effect which is added last time from current video data. Referring to FIG. 7, FIG. 7 is a schematic diagram of the effect request sending module 610 of the video conversation terminal according to another embodiment of present disclosure. The effect request sending module 610 includes the following modules.

A target effect selecting module 611, which is configured to select target effect identification from the effect material collection. The target effect identification can be read from the effect material collection which is pre-obtained. The effect material collection includes at least one effect material, an effect identification and effect type information corresponding to each material. The target effect selecting module 611 displays all of or part of effect thumbnails of the effect materials of the effect material collection on a video conversation program interface, and obtains the target effect identification corresponding to the effect material which is selected by the user. A process of obtaining target effect type information is similar with the process of obtaining target effect identification.

A effect request sending module 612, which is configured to send an effect change request with the target effect identification to the second conversation terminal, and request the second conversation terminal to change effect to current local video data according to the effect change request. In detail, the first conversation terminal displays the local image detecting information together with opposite side image detecting information. When the user moves the effect thumbnail of the target effect material selected by the user to the opposite side image detecting information, the effect request sending module 612 sends an effect change request to the second conversation according to the operation of the user. The effect change request carries with the target effect identification of the target effect material selected by the user. When the user of the first conversation terminal wants to request the second conversation terminal to clear all the effect materials of the current video data, the user can select an clearing instruction, select the opposite side image detecting information which is displayed, the effect request sending module 612 sends an effect changing request for clearing all effect to the second conversation terminal according to the operation of the user.

A video conversation module 620, which is configured to obtain the video data which effect is changed from the second conversation terminal, and display the video data which is sent from the second conversation terminal and the effect is changed during the video conversation between second conversation terminal.

Alternatively, the video conversation terminal in the embodiment further includes the following modules.

A image detecting and displaying module 630, which is configured to receive and display opposite side image detecting information sent from the second conversation terminal. Take detecting a face of the video image for example, the image detecting information is displaying a blue frame for tracking face on the local video image of the second conversation terminal to indicate the area in the blue frame is face. When the image detecting and displaying module 630 receives the opposite side image detecting information sent in a certain time period from the second conversation terminal, the image detecting and displaying module 630 displays the opposite side image detecting information on a display window provided by the video conversation program, and updates the opposite side image detecting information in time. Alternatively, the image detecting and displaying module 630 is further configured to display local image detecting information of the first conversation terminal. In another word, the image detecting and displaying module 630 starts the local image detecting component, detects current local video image, obtains the local image detecting information, and displays the local image detecting information together with the opposite side image detecting information.

Alternatively, the video conversation terminal in the embodiment further includes the following modules.

An opposite side image requesting module 640, which is configured to send an image detecting request to the second conversation terminal.

In detail, when the first conversation terminal obtains the target effect identification selected by the user, the opposite side image requesting module 640 is further configured to send an image detecting request to the second conversation terminal. For example, the opposite side image requesting module 640 obtains an operation to the effect thumbnail which is selected by clicking the effect menu, and obtains the target effect identification corresponding to the effect material which is selected by the user.

Alternatively, the video conversation terminal in the embodiment further includes the following modules.

An effect material obtaining module 650, which is configured to obtains the effect material collection from a server. In detail, the effect material obtaining module 650 automatically obtains the effect material collection from the server when the effect material obtaining module 650 initiates the request for establishing the video conversation to the second conversation terminal or when the effect material obtaining module 650 receives the request initiated by the second conversation terminal for establishing the video conversation. The effect material obtaining module 650 may obtain the effect material collection from the server before initiating the video conversation. For example, the effect material obtaining module 650 automatically obtains the effect material collection from the server according to instruction of the user, or obtains effect material collection from the server from the last video conversation, and stores the effect material collection into a preset file or a preset database.

A video conversation system is provided in an embodiment of present disclosure. The video conversation system includes a first conversation terminal and a second conversation terminal.

The first conversation terminal can be the video conversation terminal described in FIG. 4 and FIG. 5. The first conversation terminal is configured to send effect change request to the second conversation terminal, and obtains video data which effect is changed by the second conversation terminal.

The second conversation terminal can be the video conversation terminal described in FIG. 6 and FIG. 7. The second conversation terminal is configured to obtain the effect change request sent from the first conversation, change effect to current local video data according to the effect change request, and send the video data which effect is changed to the first conversation terminal.

In the embodiment of present disclosure, both sides of the video conversation can send effect change request to each other. Thus, during the video conversation, each side of the video conversation can add or clear effect to itself and the other side of the video conversation. Many types of effect can be used, interactivity and flexibility of the video conversation is improved during the conversation, and use experience of the video conversation is also improved.

A person having ordinary skills in the art can realize that part of or all of the processes in the methods according to the above embodiments may be implemented by a computer program instructing relevant hardware. The program may be stored in a computer readable storage medium. When the program is executed, the program may execute processes in the above-mentioned embodiments of methods. The storage medium may be a magnetic disk, an optical disk, a Read-Only Memory (ROM), a Random Access Memory (RAM), et al.

The foregoing descriptions are merely exemplary embodiments of present disclosure, but not intended to limit the protection scope of the present disclosure. Any variation or replacement made by a person of ordinary skills in the art without departing from the spirit of the present disclosure shall fall within the protection scope of the present disclosure. Therefore, the scope of the present disclosure shall be subject to be appended claims.

What is claimed is:

1. A video conversation method, comprising:
a first conversation terminal sending an effect change request to a second conversation terminal;
the second conversation terminal changing effect to current local video data of the second conversation terminal according to the effect change request; and
the second conversation terminal sending video data which effect is changed to the first conversation terminal.

2. The video conversation method according to claim 1, before the step of a first conversation terminal sending an effect change request to a second conversation terminal, further comprising:
the first conversation terminal receiving and displaying an opposite side image detecting information sent from the second conversation terminal.

3. The video conversation method according to claim 2, before the step of the first conversation terminal receiving and displaying opposite side image detecting information sent from the second conversation terminal, further comprising:
the first conversation terminal sending an image detecting request to the second conversation terminal.

4. The video conversation method according to claim 2, comprising:
displaying local image detecting information when the first conversation terminal receiving and displaying opposite side image detecting information sent from the second conversation terminal;
and the step of a first conversation terminal sending an effect change request to a second conversation terminal, comprising:
the first conversation terminal sending an effect change request to the second conversation according to an operation to the opposite side image detecting information selected by the user.

5. The video conversation method according to claim 1, wherein the effect change request comprises target effect identification; the step of the second conversation terminal changing effect to current local video data of the second conversation terminal according to the effect change request, comprises:
obtaining a target effect material corresponding to the target effect identification from a pre-stored effect material collection, the effect material collection comprises at least one effect material and an effect identification corresponding to each effect material;
the second conversation terminal combines current local video data of the second conversation terminal with the target effect material.

6. The video conversation method according to claim 5, before the step of second conversation terminal changing effect to current local video data of the second conversation terminal according to the effect change request, comprising:
the second conversation terminal obtaining the effect material collection from a server.

7. The video conversation method according to claim 5, wherein the effect material collection further comprises an effect type corresponding to each effect material;
the step of the second conversation terminal combines current local video data of the second conversation terminal with the target effect material, comprises:
the second conversation determining whether current local video comprises effect material having the same effect type with the target effect material; when the current local video data comprises effect material having the same effect type with the target material, replacing the effect material having the same effect type with the target effect material of the current local video data with the target effect material; otherwise, combining the target effect material with current local video data of the second conversation terminal.

8. The video conversation method according to claim 5, before the step of a first conversation terminal sending an effect change request to a second conversation terminal, further comprising:
the first conversation terminal obtaining the effect material collection from the server, the effect material collection comprising at least one effect material and an effect identification corresponding to each effect material;
the first conversation terminal selecting the target effect identification from the effect material collection.

9. A video conversation terminal, comprising:
an effect request obtaining module, configured to obtain an effect change request sent from a first conversation terminal;
an effect changing module, configured to change effect to current local video data of a second conversation terminal according to the effect change request; and
a video conversation module, configured to send video data which effect is changed to the first conversation terminal.

10. The video conversation terminal according to claim 9, further comprising:
an opposite side image sending module, configured to send opposite side image detecting information to the first conversation terminal.

11. The video conversation terminal according to claim 10, further comprising:
an image request obtaining module, configured to obtain an image detecting request sent from the first conversation terminal, and trigger the opposite side image sending module to send the image detecting information to the first conversation terminal according to the image detecting request.

12. The video conversation terminal according to claim 9, wherein the effect change request obtained by the effect request obtaining module comprises a target effect identification;
the effect changing module comprises:
an effect material searching module, configured to obtain target effect material corresponding to the target effect identification from a pre-stored effect material collection, the effect material collection comprises at least one effect material and an effect identification corresponding to each effect material; and
a combining module, configured to combine the target effect material with current local data.

13. The video conversation terminal according to claim 12, further comprising:
an effect material obtaining module, configured to obtain the effect material collection from a server.

14. The video conversation terminal according to claim 13, wherein the effect material collection further comprises an effect type corresponding to each effect material;
the combining module comprises:
an effect type determining module, configured to determine whether current local video data includes the effect material having the same effect type with the target effect material;
a replacing module, configured to replace the effect material having the same effect type with the target effect material of the current local video data with the target effect material, when the effect type determining module determines the current local video data comprises the effect material having the same effect type with target effect material; and
an adding module, configured to combine the target effect material with current local data of the second conversation terminal, when the effect type determining module determines the current local video data does not comprises the effect material having the same effect type with target effect material.

15. A video conversation terminal, comprising:
an effect request sending module, configured to send an effect change request to a second conversation terminal, request the second conversation terminal to change effect to current local video data; and
a video conversation module, configured to obtain the video data which effect is changed from the second conversation terminal.

16. The video conversation terminal according to claim 15, further comprising:
an image detecting and displaying module, configured to receive and display opposite side image detecting information sent from the second conversation terminal.

17. The video conversation terminal according to claim 16, further comprising:
an opposite side image requesting module, configured to send an image detecting request to the second conversation terminal.

18. The video conversation terminal according to claim 16, wherein the image detecting and displaying module is further configured to display local image detecting information of the first conversation terminal;
the effect request sending module is configured to send an effect change request to the second conversation according to an operation to the opposite side image detecting information selected by the user.

19. The video conversation terminal according to claim 15, further comprising:
an effect material obtaining module, configured to obtain the effect material collection from a server, the effect material collection comprises at least one effect material and an effect identification corresponding to each effect material;
the effect request sending module comprising:
a target effect selecting module, configured to select target effect identification from the effect material collection; and
an effect request sending module, configured to send an effect change request with the target effect identification to the second conversation terminal, make the second conversation terminal combine current local video data of the second conversation terminal with the target effect material.
